(19) United States
(12) Patent Application Publication
(10) Pub. No.: US 2014/0020342 A1
(43) Pub. Date: Jan. 23, 2014

(54) MULTI-PURPOSE BAG

(71) Applicants: Henry James Bellingham, IV, Charleston, SC (US); Eric Hardinge Langsam, Charleston, SC (US); Philip Arthur Wilheit, Atlanta, GA (US)

(72) Inventors: Henry James Bellingham, IV, Charleston, SC (US); Eric Hardinge Langsam, Charleston, SC (US); Philip Arthur Wilheit, Atlanta, GA (US)

(21) Appl. No.: 13/947,986

(22) Filed: Jul. 22, 2013

Related U.S. Application Data
(60) Provisional application No. 61/673,978, filed on Jul. 20, 2012.
(60) Provisional application No. 61/758,089, filed on Jan. 29, 2013.

(51) Int. Cl. B65F 1/00

(52) U.S. Cl. CPC B65F 1/002
USPC 53/469; 383/211; 383/10

(57) ABSTRACT

The present invention provides a recyclable multi-purpose bag. In one embodiment, the bag comprises an enclosure having a body member defining a first opening, a second opening, and an end member enclosing the second opening, wherein the body member comprises at least one perforated portion defining an interior portion, wherein the perforated portion is structured such that the interior portion can be at least partially removed to define a handle. The first opening of the bag is structured to be sealed after filling the bag with the debris. Further, the bag comprises a first cohesive layer applied to a first portion of the body member and a second cohesive layer applied to a second portion of the body member, wherein the first cohesive layer and the second cohesive layer are structured to bond when the first and second cohesive layers contact one another.

### BACKGROUND OF THE INVENTION

1. Field of the invention

The present invention relates generally to multi-purpose bags used for storing debris.

2. Description of Related Art

Most municipalities require residents to place leaves and yard debris in large paper bags for pick up. These bags are often made with recycled paper and/or plastic. The conventional bags used to collect debris are generally closed at one end when the bag is made. The bags are filled with debris through the open end of the bag. Conventional bags have disadvantages. For example, when these bags are placed on the street for pick up, the bag may be blown over by strong winds or knocked over, resulting in the contents spilling. This causes an inconvenience to the user, who must clean up the spilled debris. Also, waste collectors prefer the debris to remain within the bag during transport for convenient disposal. Accordingly, there remains a need for multi-purpose bags that are not prone to spillage.

### SUMMARY OF THE INVENTION

Debris is commonly packaged in bags, sacks, or other packaging materials. As used herein, the term “debris” refers to materials including, but not limited to, lawn remains (e.g., grass clippings, leaves, or the like), household items (e.g., clothing, bedding, or the like), recyclable material (e.g., aluminum cans, plastic bottles, organic refuse, or the like), and other refuse.

The present invention provides a multi-purpose bag for storing debris. In one exemplary embodiment, the bag comprises an enclosure having a body member defining a first opening, a second opening, and an end member enclosing the second opening, wherein the body member comprises at least one perforated portion defining an interior portion, wherein the interior portion can be at least partially removed to define a handle. Further, the bag comprises a first cohesive layer applied to a first portion on the body member and a second cohesive layer applied to a second portion on the body member, wherein the first cohesive layer and the second cohesive layer are structured to bond when the first and second cohesive layers contact one another. In some embodiments, the body member comprises an extension member capable of at least partially enclosing the first opening, wherein the second cohesive layer is positioned on the extension member. In another embodiment, the bag comprises a reinforcement member, wherein the reinforcement member is positioned on the body member such that it encompasses the at least one perforated portion.

In some embodiments, a method for storing debris is presented, the method comprises: providing an enclosure comprising a body member defining a first opening, a second opening, and an end member enclosing the second opening; filling the enclosure with debris; and sealing the enclosure at least partially by rolling the edges of the enclosure at the first opening together such that a first cohesive layer applied to a first portion on the body member and a second cohesive layer applied to a second portion on the body member come into contact and bond.

In another exemplary embodiment, the bag comprises an enclosure having a body member defining a first opening, a second opening, and an end member at least partially enclosing the second opening. In addition, the bag comprises an extension member attached to and extending from the body member, wherein the extension member is capable of at least partially enclosing the first opening. Also, the bag comprises a first cohesive layer applied to a first portion on the body member and a second cohesive layer applied to a second portion on the extension member, wherein the first cohesive layer and the second cohesive layer are structured to bond when the first and second cohesive layers contact one another. In one embodiment, the body member comprises at least one perforated portion defining an interior portion, wherein the perforated portion is structured such that the interior portion can be at least partially removed to define a handle. In some embodiments, the body member defines an expandable handle.

In some embodiments, a method for storing debris is presented, the method comprises: providing an enclosure comprising a body member defining a first opening, a second opening, and an end member enclosing the second opening, wherein the enclosure further comprises an extension member extending from the body member; filling the enclosure with debris; and sealing the enclosure at least partially by positioning the extension member over the first opening such that a first cohesive layer applied to a first portion on the body member and a second cohesive layer applied to a second portion on the extension member come into contact and bond.

### BRIEF DESCRIPTION OF THE DRAWINGS

The foregoing and other advantages and features of the invention, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is a front, top, right-side perspective view of a multi-purpose bag, according to a first embodiment of the invention.

FIG. 2 is a front elevational view of the bag of FIG. 1.

FIG. 3 is a rear elevational view of the bag of FIG. 1.

FIG. 4 is a right-side elevational view of the bag of FIG. 1.

FIG. 5 is a left-side elevational view of the bag of FIG. 1.

FIG. 6 is a plan view of the first opening of the bag of FIG. 1.

FIG. 7 is a plan view of the end member of the bag of FIG. 1.

FIG. 8 is a front, top, right-side perspective view of a multi-purpose bag, according to a second embodiment of the invention.

FIG. 9 is a front, top, right-side perspective view of the multi-purpose bag of FIG. 1 having been sealed.

FIG. 10 is a front, top, right-side perspective view of a multi-purpose bag, according to a third embodiment of the invention.

FIG. 11 is a front elevational view of the bag of FIG. 10.

FIG. 12 is a rear elevational view of the bag of FIG. 10.

FIG. 13 is a right-side elevational view of the bag of FIG. 10.

FIG. 14 is a left-side elevational view of the bag of FIG. 10.

FIG. 15 is a plan view of the first opening of the bag of FIG. 10.

FIG. 16 is a plan view of the end member of the bag of FIG. 10.

FIG. 17 is a front, top, right-side perspective view of the multi-purpose bag of FIG. 10 having been sealed.

### DETAILED DESCRIPTION OF THE INVENTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

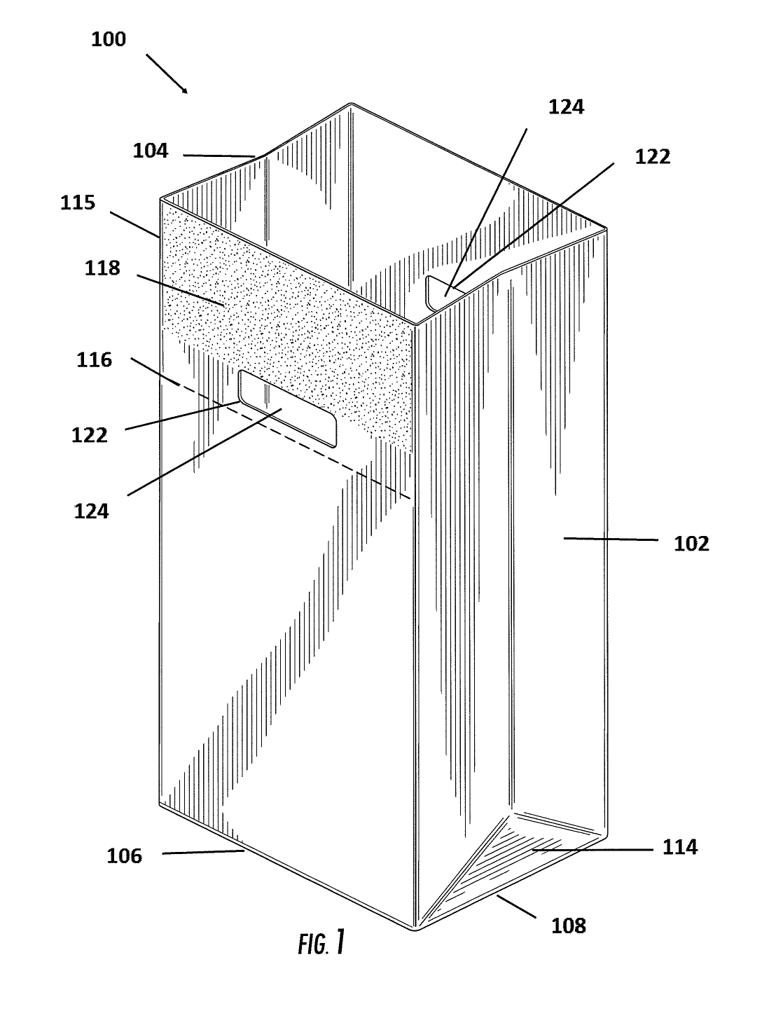

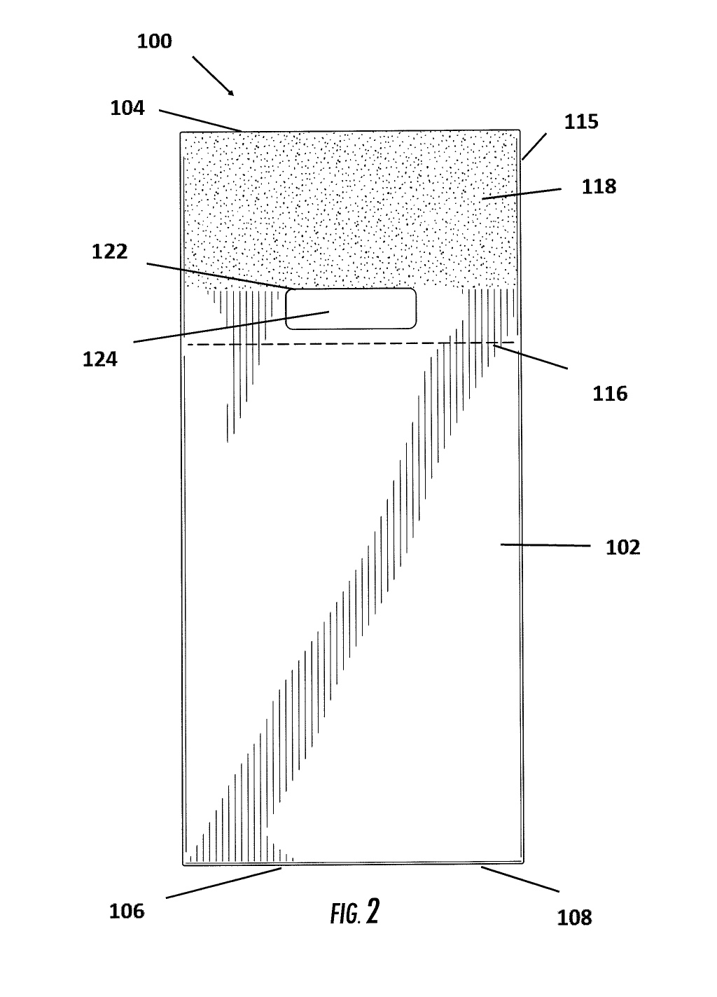

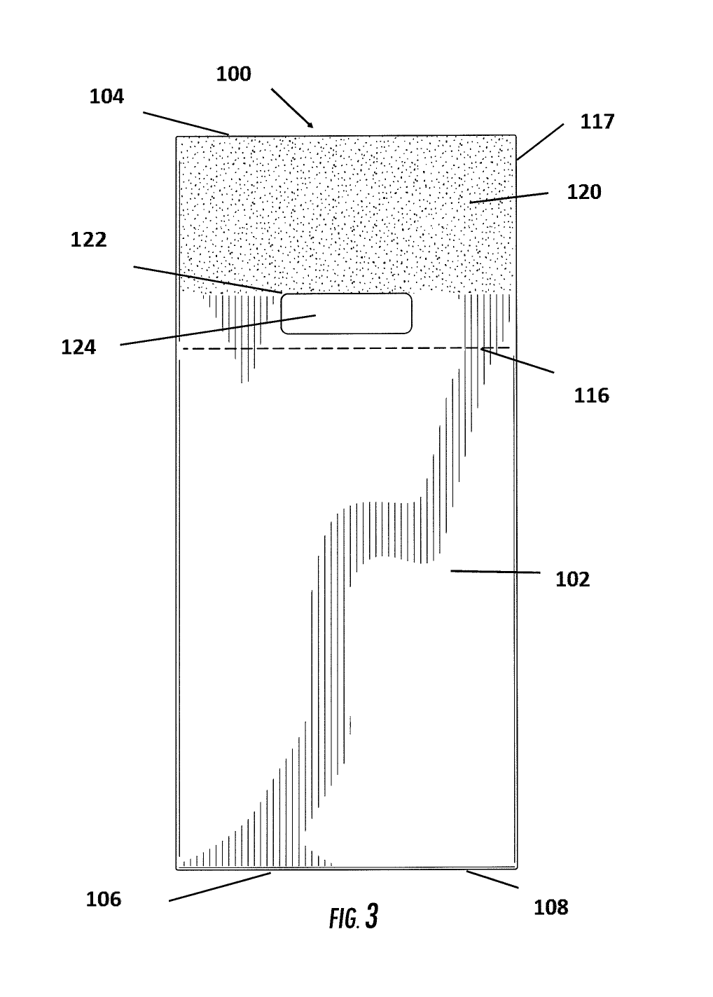

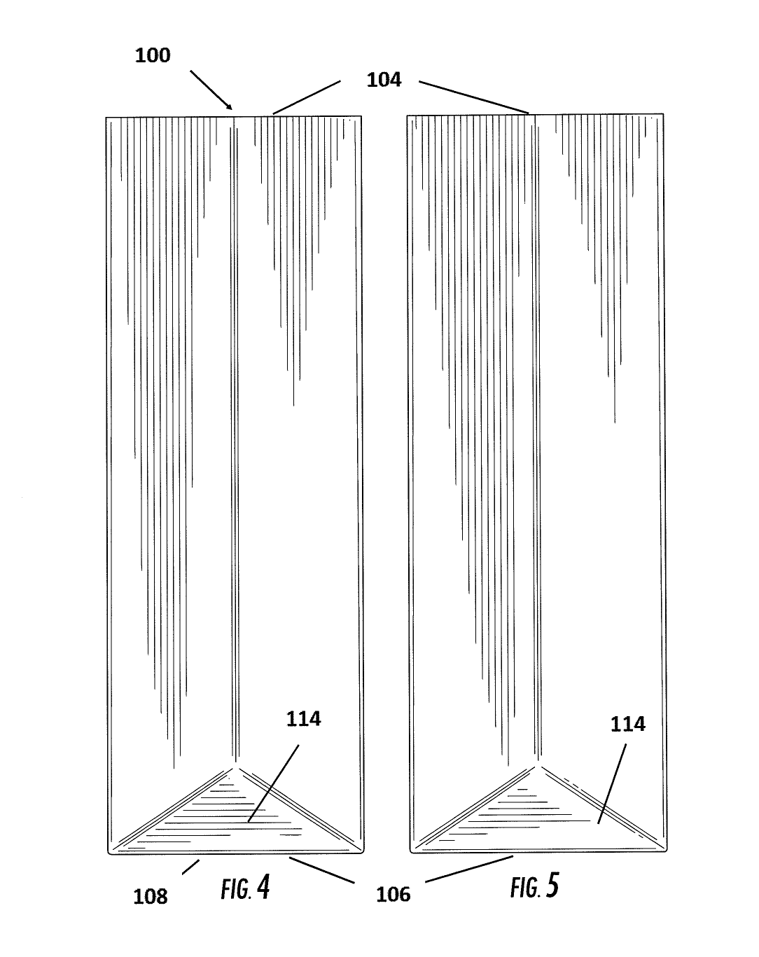

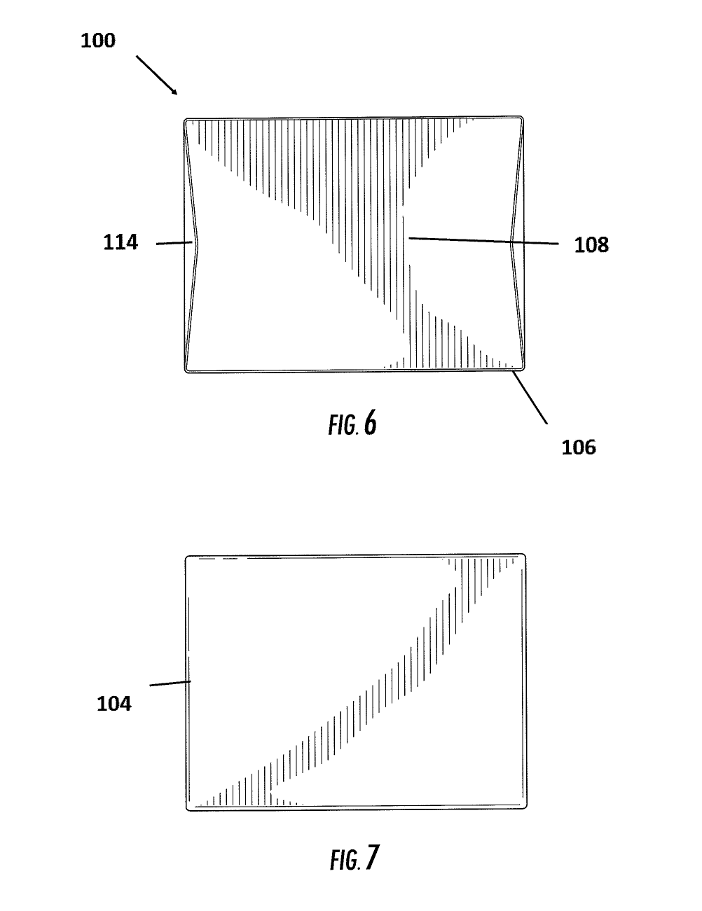

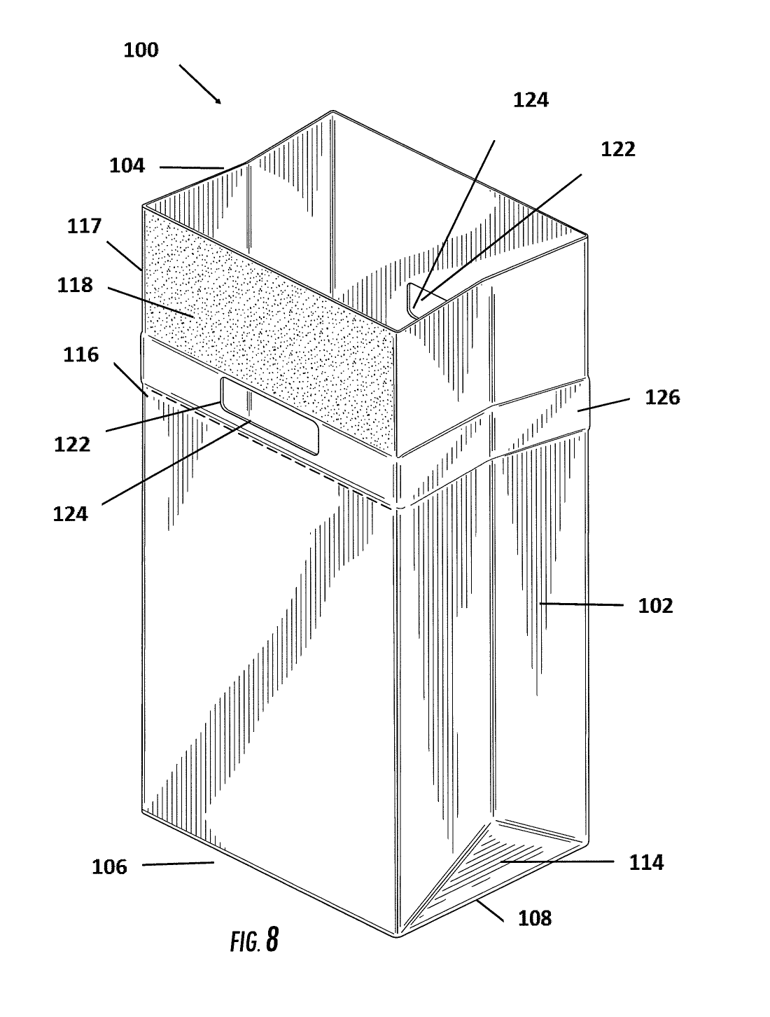

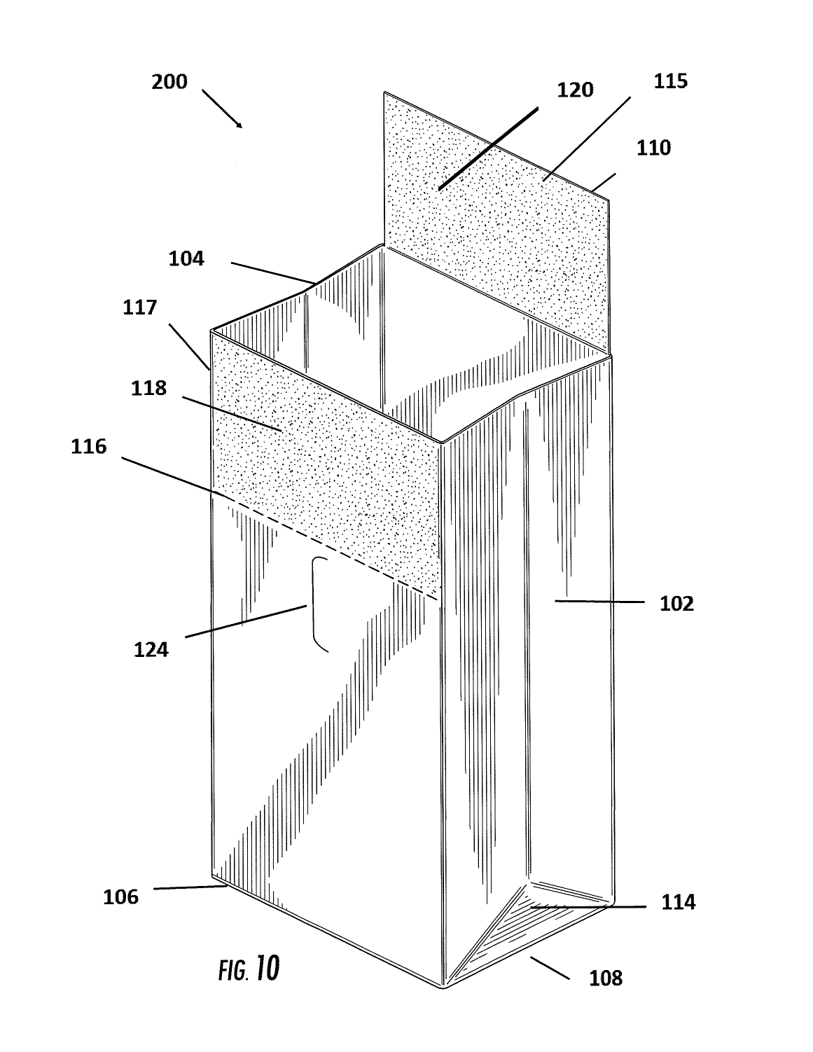

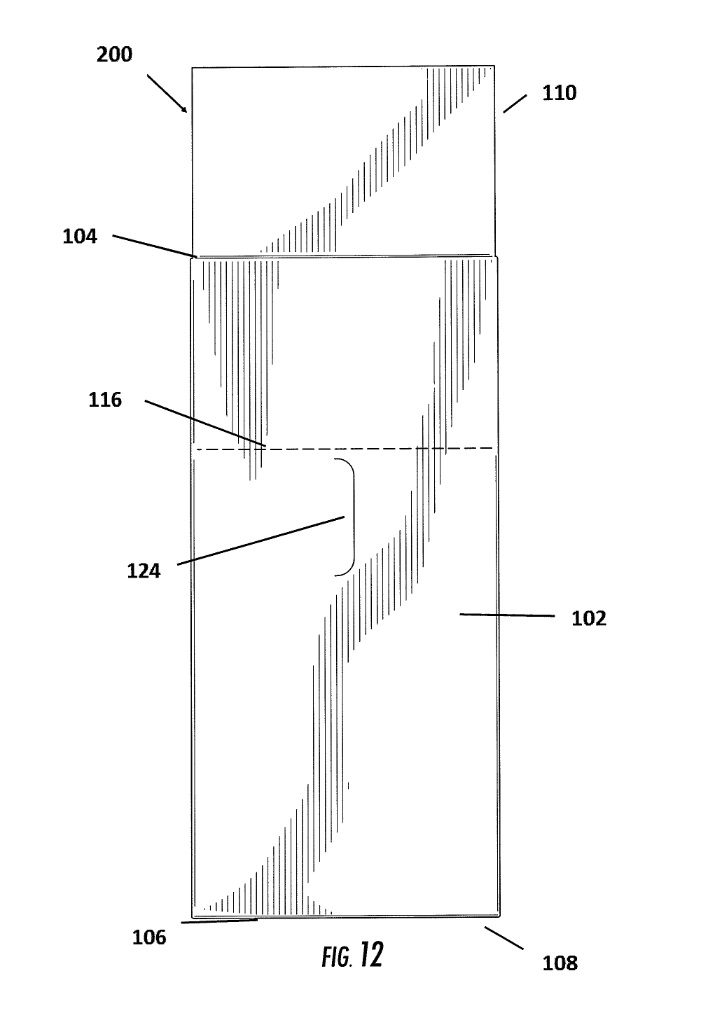

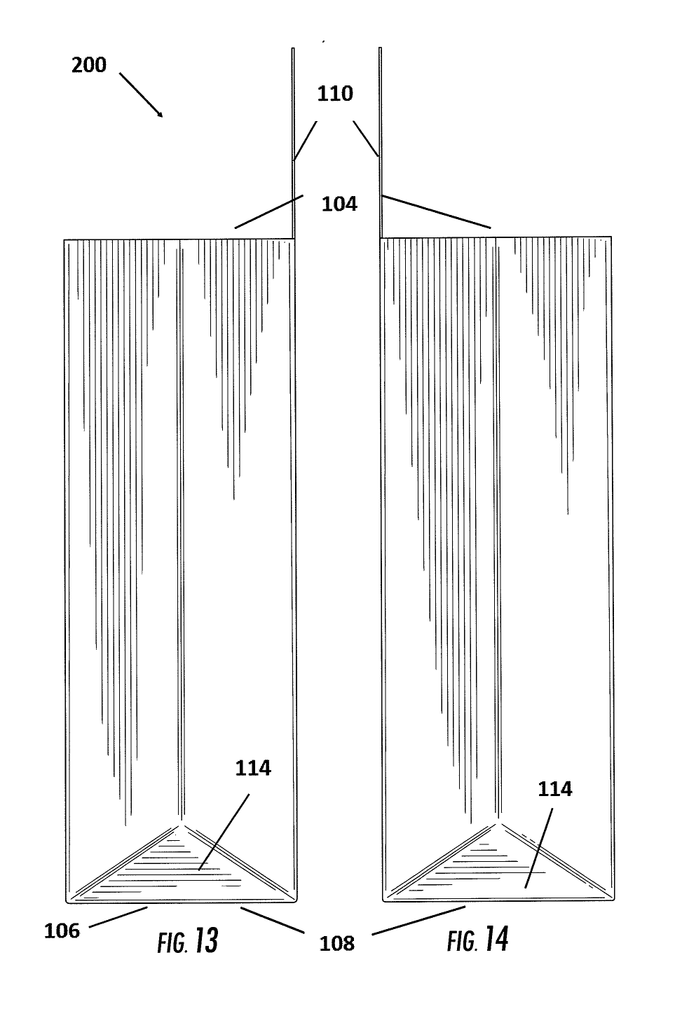

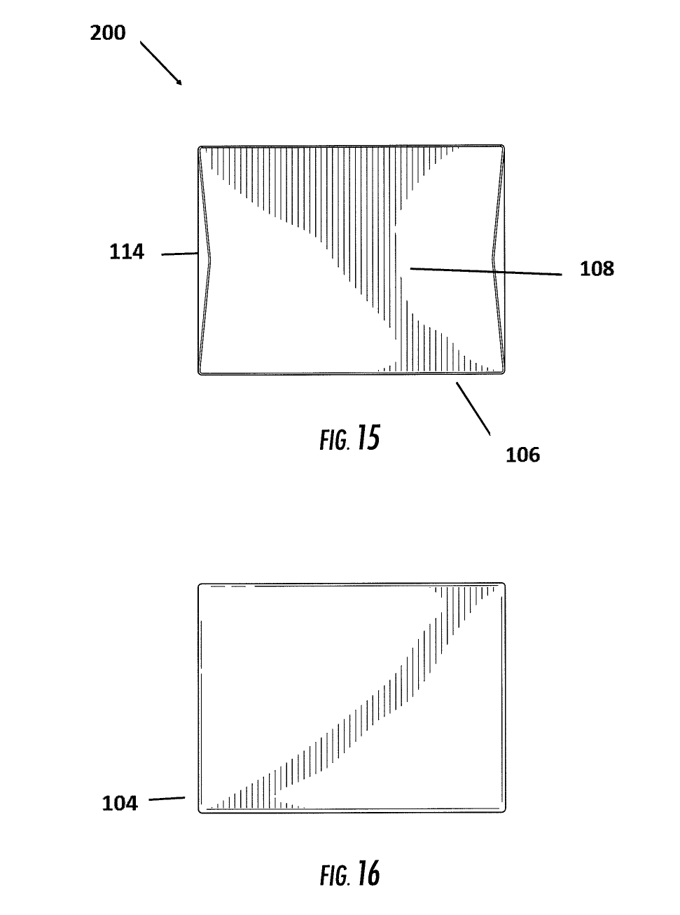

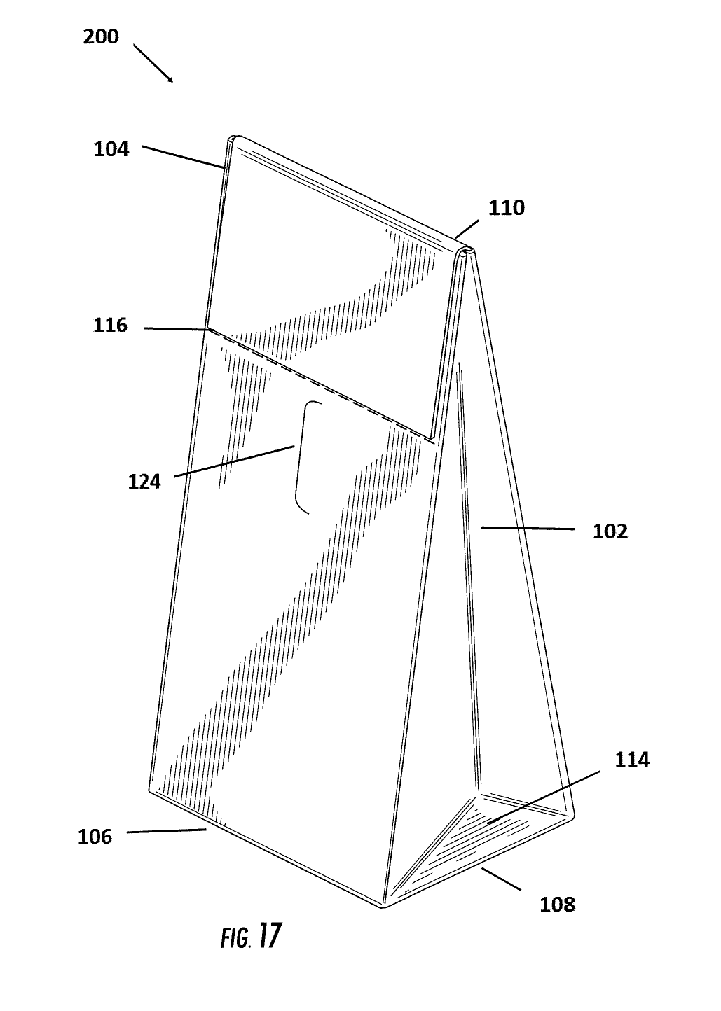

FIGS. 1 through 7 illustrate a multi-purpose bag 100, according to one embodiment of the present invention. The bag includes an enclosure having a body member 102 defining a first opening 104 and a second opening 106, and an end member 108 that encloses the second opening 106. In the embodiment illustrated in FIGS. 10-17, the body member 102 comprises an extension member 110. In one embodiment, the bag 100 is constructed, in whole or in part, of recycled materials, such as paper and/or plastic. For purposes of example only and not limitation, in one embodiment, the bag 100 may be constructed from a paper or paperboard material produced from chemical pulp produced by pulping processes such as the kraft process. In one embodiment, at least a portion of the material is recycled material, although virgin material may also be used in whole or in part. In one embodiment, the bag 100 is constructed using 2 ply kraft paper with a 30 gallon/50 lbs. capacity. In another embodiment, the bag 100 is constructed such that the body member 102 comprises an inner layer of a 2 ply virgin kraft paper and an outer layer of a ply wet-strength paper. In yet another embodiment, the bag 100 is constructed such that the inner and the outer layers are both ply wet-strength paper for extended stability and durability in bad weather.

The bag 100 can be formed by securing the ends of an elongate piece of material using adhesives to thereby form a body member having first 104 and second openings 106. Then the end member 108 can be secured to the body member 102 using adhesives to cover the second opening 106. The extension member 110 illustrated in FIG. 10 may also be attached to the body member 102 using adhesives. Alternatively, the body member 102 and end member 108 can be formed from one piece of material into a unitary design. Similarly, the body member 102 and extension member 110 can be formed from one piece of material into a unitary design. As illustrated in FIGS. 9 and 17, when the bag 100 is filled, it assumes a generally rectangular or cubical configuration with generally square ends formed by the triangular portions 114 and four interconnecting side walls each of which is generally rectangular. Alternatively, the bag 100 can be constructed such that the configuration is circular and tubular.

In one embodiment, the bag 100 includes a fill line 116 on at least one surface of the body member and located proximate to the first opening 102 of the bag. In one embodiment, the fill line 116 is printed on the bag 100.

As illustrated in FIGS. 1, 2, 3, 10 and 11, the bag includes a first cohesive layer 118 applied to a first portion 115 of the body member and a second cohesive layer 120 applied to a first portion 117 of the body member. The first and second cohesive layers 118, 120 comprise materials that are structured not to be sticky or tacky to the touch once the material is applied to the first portion 115 of the body member and the first portion 117 of the body member, respectively, and dries, but once the first and second cohesive layers 118, 120 come into contact with one another, they are structured to bond together. In one embodiment, the first and second cohesive layers 118, 120 comprise formulated rubber latex. In one embodiment, the first and second cohesive layers 118, 120 can comprise a formulated rubber latex product sold by Henkel Americas under the brand names AQUENCE ENV and ADHESIN, including, without limitation, product numbers 35-027A, 35-6143, 35-6148 and 35-6199. In another embodiment, the first and second cohesive layers 118, 120 can comprise a formulated rubber latex product sold by National Starch and Chemical Company under the brand names NATIONAL and RESYN®, including, without limitation, product numbers 35-6143, 35-6148, and 35-6199. In one embodiment, the first and second cohesive layers are applied by spraying the material or by applying the material with a roller.

As illustrated in FIGS. 1, 2, 3, 10 and 11, in one embodiment, the first portion 115 of the body member is positioned proximate to the first opening 104. In a preferred embodiment, the first portion 115 is positioned between the edge of the first opening 104 and the edge of the perforated portion 122, which is described more fully below. In the embodiment illustrated in FIGS. 1, 2, and 3, the second cohesive layer 120 is applied to a first portion 117 of the body member on the opposite side of the body member 102. As illustrated in FIG. 9, in order to seal the bag, the user “rolls” the edges of the bag together to thereby cause the first cohesive layer 118 and second cohesive layer 120 to come into contact and to bond together and form a seal that at least partially encloses the first opening 104. Advantageously, by “rolling” the edges together, the contact surface area can be greater compared to if the edges were simply slightly overlaid and, moreover, the “rolling” of the edges together provides multiple layers of bonded surface area within the “rolled” edges that resist any force applied against the seal, for example, if the bag were overturned and the debris pressed against the seal. As used herein, “roll” includes rolling the edges to form a cylindrical structure or “seal” or, alternatively, can include folding or any other method involving overlaying the first cohesive layer 118 and second cohesive layer 120 in a repetitive fashion.

In the embodiment illustrated in FIGS. 10, 11 and 12, the second cohesive layer 120 is applied to a first portion 117 positioned on the extension member 110. As illustrated in FIG. 17, in order to seal the bag, the user positions the extension member 110 so that the second cohesive layer 120 applied to the first portion 117 positioned on the extension member 110 at least partially overlays the first cohesive layer 118 thereby causing the first cohesive layer 118 and second cohesive layer 120 to come into contact and to bond together and form a seal. Once sealed, the extension member 110 at least partially encloses the first opening 104.

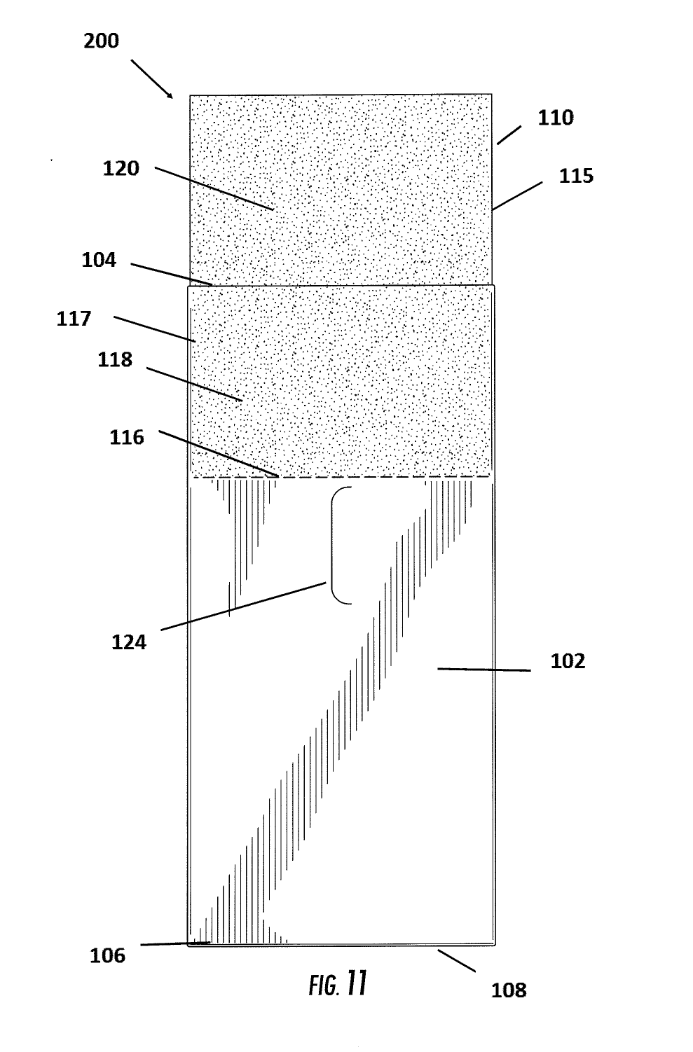

According to one embodiment, the bag comprises at least one perforated portion 122 defining an interior portion 124, wherein the perforated portion is structured such that the interior portion 124 may be at least partially removed to define a handle. While the perforated portion 122 can be positioned anywhere along the body member 102, preferably it is positioned in a location that will provide the user with a handle that may be used during filling and after the bag is filled and sealed. For example, as illustrated in FIGS. 1-3, a substantially, horizontally-oriented perforated portion 122 can be positioned above the fill line 116, but below the first cohesive layer 118 applied to the first portion 115 of the body member 102, and a substantially, horizontally-oriented perforated portion 122 can be positioned above the fill line 116, but below the second cohesive layer 120 applied to the first portion 117 of the body member 102. In another embodiment, as illustrated in FIGS. 10 and 11, a first substantially, vertically-oriented perforated portion 122 can be positioned proximate to, but below the fill line 116, and a second substantially, vertically-oriented perforated portion can be positioned proximate to, but below the fill line 116 on the side of the body member 102 opposite to the side having the first perforated portion 122. In one embodiment, the perforated portion is positioned approximately 9 inches below the fill line and centered along the width of the rear surface. In yet another embodiment, one or more expandable handles can be secured to the body member 102. In some embodiments, the perforated portion may be formed using at least one of a pins and needles process, die and punch process, laser perforations process, or the like. The orientation and configuration of the perforated portions or expandable handle also may vary.

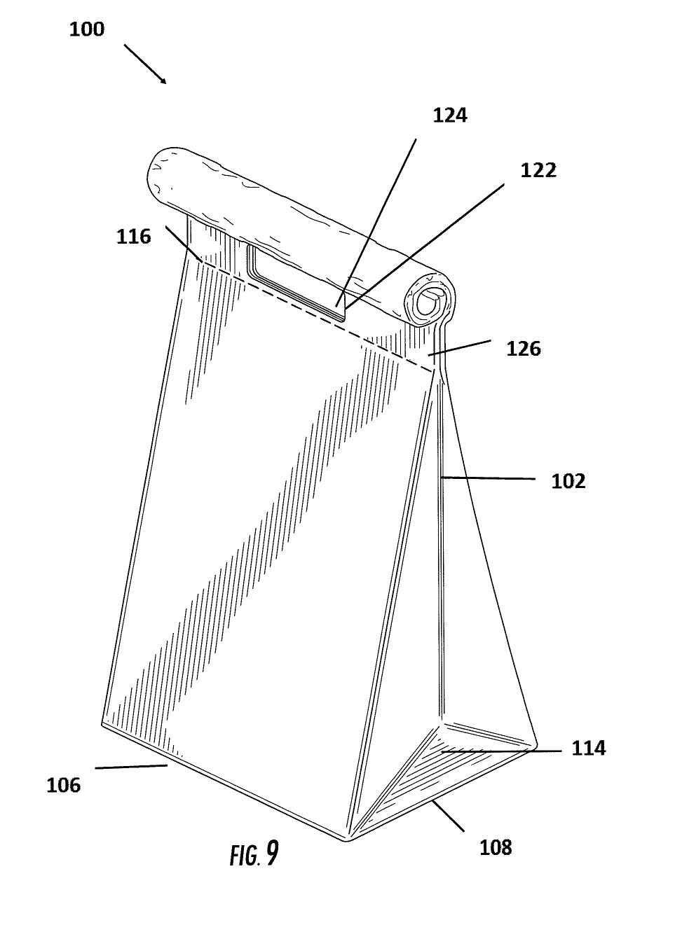

In one embodiment, as illustrated in FIG. 8, the bag 100 comprises a reinforcement member 124 positioned on the body member 102 such that the reinforcement member 124 encompasses at least one perforated member 124. In this regard, the reinforcement member 126 would also be perforated. In one embodiment, the reinforcement member 126 can be positioned along a length of, or even the entire length of the circumference of the bag 100. Advantageously, having the reinforcement member 126 positioned along all or a substantial portion of the circumference of the bag 100 provides support to maintain the first opening 104 in an open position when the bag 100 is being filled and also prevents tears or rips emanating from the first opening 104 down the length of the body member 102. The reinforcement member 126 may be formed of a variety of materials that are thin, lightweight, have some flexibility and can be readily adhered to paper and/or plastic. For purposes of example only not limitation, the reinforcement member may be made of fiberglass, woven fiber, or the like.

In the embodiment illustrated in FIG. 1, the front and rear surfaces of the bag 100 may be 35 inches long and 16 inches wide. The two lateral sides of the bag 100 may be 35 inches long and 12 inches wide. The fill line 116 on the front surface may be located 10 inches from the edge of the first opening 104 of the bag 100. The perforated portion 122 may be 1 inch long and 4 inches wide. The first cohesive layer 118 applied to the first portion 115 of the body member 102 and the second cohesive layer 120 applied to the first portion 117 of the body member 102 may be 10 inches wide. In the embodiment illustrated in FIG. 10, the front surface of the bag 100 may be 35 inches long and 16 inches wide. The rear surface of the bag may be 45 to 55 inches long and 16 inches wide, making the extension member 110 about 10 to 20 inches long. The two lateral sides of the bag 100 may be 35 inches long and 12 inches wide. The fill line 116 on the front surface may be located 10 inches from the edge of the first opening 104 of the bag 100. The perforated portion may be 1 inch long and 4 inches wide. The first cohesive layer 118 applied to the first portion 115 of the body member 102 and the second cohesive layer 120 applied to the extension member 110 may be 10 inches wide.

In another embodiment, the back may include interior support members, such as plastic, fiberglass or metal rods that are positioned vertically, horizontally, and/or at an angle (e.g., diagonally). Such support members can provide additional rigidity to the bag during filling.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for storing debris, comprising:
an enclosure having a body member defining a first opening, a second opening, and an end member enclosing the second opening, wherein the body member comprises at least one perforated portion defining an interior portion, wherein the perforated portion is structured such that the interior portion can be at least partially removed to define a handle;
a first cohesive layer applied to a first portion of the body member; and
a second cohesive layer applied to a second portion of the body member, wherein the first cohesive layer and the second cohesive layer are structured to bond when the first and second cohesive layers contact one another.

2. The apparatus of claim 1, wherein the body member comprises an extension member capable of at least partially enclosing the first opening, wherein the second cohesive layer is positioned on the extension member.

3. The apparatus of claim 1, further comprising a reinforcement member, wherein the reinforcement member is positioned on the body member such that it encompasses the at least one perforated portion.

4. An apparatus for storing debris, comprising:
an enclosure having a body member defining a first opening, a second opening, and an end member at least partially enclosing the second opening, the enclosure further comprising an extension member extending from the body member, wherein the extension member is capable of at least partially enclosing the first opening;
a first cohesive layer applied to a first portion on the body member; and
a second cohesive layer applied to a second portion on the extension member, wherein the first cohesive layer and the second cohesive layer are structured to bond when the first and second cohesive layers contact one another.

5. The apparatus of claim 4, wherein the body member comprises at least one perforated portion defining an interior portion, wherein the perforated portion is structured such that the interior portion can be at least partially removed to define a handle.

6. The apparatus of claim 4, wherein the body member defines an expandable handle.

7. A method for storing debris, the method comprising:
providing an enclosure comprising a body member defining a first opening, a second opening, and an end member enclosing the second opening;
filling the enclosure with debris; and
sealing the enclosure at least partially by rolling the edges of the enclosure at the first opening together such that a first cohesive layer applied to a first portion of the body member and a second cohesive layer applied to a second portion of the body member come into contact and bond.

8. A method for storing debris, the method comprising:
providing an enclosure comprising a body member defining a first opening, a second opening, and an end member enclosing the second opening, wherein the enclosure further comprises an extension member extending from the body member;
filling the enclosure with debris; and
sealing the enclosure at least partially by positioning the extension member over the first opening such that a first cohesive layer applied to a first portion of the body member and a second cohesive layer applied to a second portion of the extension member come into contact and bond.
